(19) United States
(12) Patent Application Publication
(10) Pub. No.: US 2012/0274620 A1
(43) Pub. Date: Nov. 1, 2012

(54) DATA WRITING APPARATUS FOR E-PAPER AND DATA WRITING METHOD USING THE SAME

(75) Inventors: Hyun Ha Hwang, Seoul (KR); Seung Gon Kang, Hwaseong-si (KR); Heon Kyu Kim, Suwon-si (KR)

(73) Assignee: INTELLECTUAL DISCOVERY CO., LTD., Seoul (KR)

(21) Appl. No.: 13/459,714

(22) Filed: Apr. 30, 2012

(30) Foreign Application Priority Data
Apr. 29, 2011 (KR) 10-2011-0040563

(51) Int. Cl. G09G 3/34; G06F 3/038

(52) U.S. Cl. 345/211; 345/107

(57) ABSTRACT

There is provided a data writing apparatus for e-paper including a base unit on which the e-paper is provided and which applies a driving voltage corresponding to input data to the e-paper through an electrode array, and a first roller that is rotated around a central axis in a predetermined direction on the base unit and presses a part of the e-paper to be in contact with the base unit, wherein when the e-paper is pressed to be in contact with the base unit by the first roller, the base unit applies the driving voltage to the e-paper and data are written in the e-paper.

### CROSS-REFERENCE TO RELATED APPLICATION

This application claims the benefit of Korean Patent Application No. 10-2011-0040563 filed on Apr. 29, 2011, the entire disclosures of which are incorporated herein by reference.

### TECHNICAL FIELD

The present disclosure relates to a data writing apparatus for e-paper and a data writing method using the same.

### BACKGROUND

Recently, electronic books and electronic billboards using various types of e-paper display have attracted a lot of attention. Such e-paper is driven mainly in a reflection mode, and, thus, it is possible to reduce eye strain and minimize power consumption.

However, typically, e-paper applied products include various voltage supply units, a control CPUs, and a backplane substrate in addition to an e-paper display. Therefore, product prices rise and a manufacturing process becomes complicated. If the e-paper is used like printed paper, the e-paper does not need to be driven continuously. Illustrative embodiments of the present disclosure provide a data writing apparatus in which the number of components additionally provided to the e-paper is minimized and data can be written in the e-paper or erased therefrom repeatedly.

In this regard, Patent Document 1 (US 2010/0295776 entitled “Epaper stamp”) describes a stamp in which e-paper is positioned on a planar substrate slantly provided and input data are written in the e-paper. Further, Patent Document 2 (JP 2000-127478 entitled “Printer for electronic paper”) describes a printer in which e-paper is inserted between a pair of drums and data are written in the e-paper. In accordance with Patent Document 1, the e-paper is positioned on a planar surface and data are written by using a stamp in a horizontal position, and, thus, the entire surface of the e-paper is difficult to be stuck to the planar surface. In accordance with Patent Document 2, the printer needs to include a transfer unit configured to transfer the e-paper between the drums at a constant speed. Further, in case of a drum-type printer, there are difficulties in providing an electrode array to a drum in a manufacturing process.

### SUMMARY

In view of the foregoing, illustrative embodiments provide an improved data writing apparatus for e-paper capable of repeatedly writing data in e-paper.

Further, the illustrative embodiments provide a data writing method for e-paper using the data writing apparatus.

In accordance with a first aspect of the illustrative embodiments, there is provided a data writing apparatus for e-paper including a base unit on which the e-paper is provided and which applies a driving voltage corresponding to input data to the e-paper through an electrode array, and a first roller that is rotated around a central axis in a predetermined direction on the base unit and presses a part of the e-paper to be in contact with the base unit, wherein when the e-paper is pressed to be in contact with the base unit by the first roller, the base unit applies the driving voltage to the e-paper and data are written in the e-paper.

In accordance with a second aspect of the illustrative embodiments, there is provided a data writing method for e-paper using a data writing apparatus including a base unit that applies a driving voltage to the e-paper and a roller that is positioned on the base unit, the data writing method including (a) positioning the e-paper on an upper surface of the base unit including an electrode array and applying the driving voltage, (b) pressing a part of the e-paper to be in contact with the base unit while the roller is moved in a predetermined direction, and (c) writing data in the e-paper by applying the driving voltage to the e-paper when the e-paper is in contact with the base unit during (b) the pressing a part of the e-paper to be in contact with the base unit.

In accordance with a third aspect of the illustrative embodiments, there is provided a data writing method for e-paper using a data writing apparatus including a base unit that applies a driving voltage to the e-paper and a roller that is positioned on the base unit, the data writing method including (a) positioning the e-paper on an upper surface of the base unit including an electrode array and applying the driving voltage, (b) pressing a part of the e-paper to be in contact with the base unit while the roller is moved in a predetermined direction, (c) erasing data written in the e-paper by applying an erasing voltage to the e-paper when the e-paper is in contact with the base unit during (b) the pressing a part of the e-paper to be in contact with the base unit, (d) pressing a part of the e-paper to be in contact with the base unit while the roller is moved in a predetermined direction, and (e) writing data in the e-paper by applying a writing voltage to the e-paper when the e-paper is in contact with the base unit during (d) the pressing a part of the e-paper to be in contact with the base unit.

In accordance with the illustrative embodiments, a conventionally known data writing apparatus for e-paper is improved, so that an e-paper medium including a minimum number of components can be used. In particular, a planar base unit is positioned at a lower side of the data writing apparatus, so that e-paper can be stably fixed to the base unit. Further, a roller is provided above the base unit and the e-paper is pressed against the base unit by the roller, so that when a voltage is applied, an effect of writing or erasing data can be maximized. Furthermore, an electrode array for applying a driving voltage to the e-paper is included in the base unit, so that a configuration of the roller can be simplified. In particular, it is possible to solve a problem in providing an electrode array to a curved surface of a roller.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 illustrates a data writing apparatus for e-paper in accordance with an illustrative embodiment;

FIG. 2 illustrates a detailed configuration of a base unit included in a data writing apparatus for e-paper;

FIG. 3 is a side view illustrating an operation status of a data writing apparatus in accordance with an illustrative embodiment;

FIG. 4 illustrates a configuration of e-paper used in illustrative embodiments;

FIG. 5 illustrates a data writing apparatus for e-paper in accordance with another illustrative embodiment;

FIG. 6 illustrates a configuration of e-paper used in illustrative embodiments;

FIG. 7 illustrates a data writing apparatus for e-paper in accordance with still another illustrative embodiment;

FIG. 8 is a flowchart illustrating a data writing method for e-paper in accordance with an illustrative embodiment; and

FIG. 9 is a flowchart illustrating a data writing method for e-paper in accordance with another illustrative embodiment.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the terms “connected to” or “coupled to” that is used to designate a connection or coupling of one element to another element includes both a case that an element is “directly connected or coupled to” another element and a case that an element is “electronically connected or coupled to” another element via still another element. Further, the terms “comprises or includes” and/or “comprising or including” used in the document means that one or more other components, steps, operation and/or existence or addition of elements are not excluded in addition to the described components, steps, operation and/or elements unless context dictates otherwise.

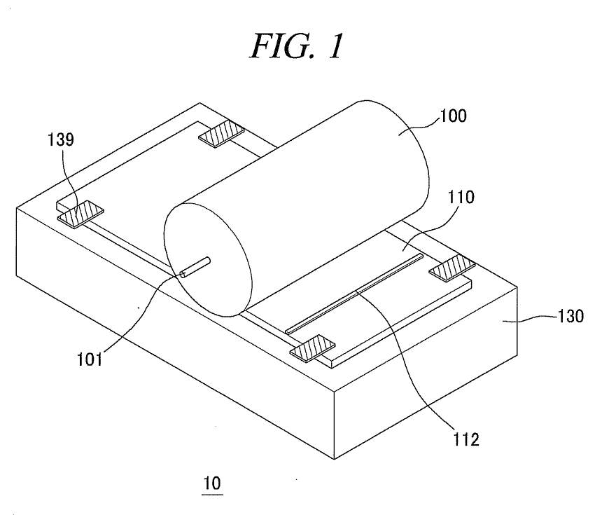

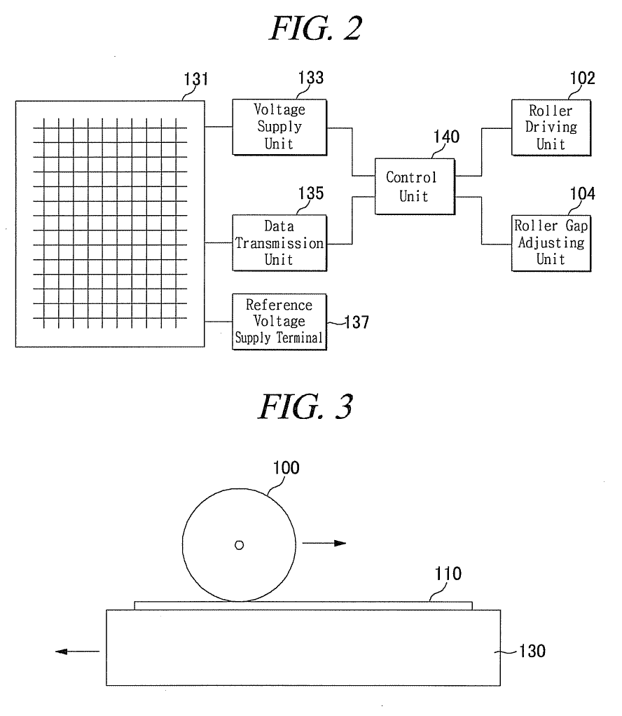

FIG. 1 illustrates a data writing apparatus for e-paper in accordance with an illustrative embodiment, and FIG. 2 illustrates a detailed configuration of a base unit included in the data writing apparatus for e-paper.

A data writing apparatus 10 includes a base unit 130 that applies a driving voltage to e-paper 110 and a roller 100 that presses the electronic paper 110 against the base unit 130.

The roller 100 is moved while rotating around a central axis 101 in a predetermined direction and presses a part of the e-paper 110 to be, in contact with the base unit 130. Typically, contact points between the cylindrical roller 100 and a planar surface form a single straight line. Thus, contact areas between the e-paper 110 and the base unit 130 form a single linear area. In this manner, the e-paper 110 can be in further contact with the base unit 130. In order to write data in the e-paper 110, a driving voltage is applied to a specific area of the e-paper 110. If the e-paper 110 is not in contact with the base unit 130, the driving voltage cannot be applied to the e-paper 110 efficiently. Therefore, in order to improve performance of the data writing apparatus 10, the roller 100 presses the e-paper 110 against the base unit 130 as close as possible.

A roller driving unit 102 such as a motor may be connected to the roller 100 to rotate the roller 100 in a specific direction. Further, a roller gap adjusting unit 104 for adjusting a contact degree between the roller 100 and the base unit 130 may be connected to the roller 100. The roller gap adjusting unit 104 adjusts the contact degree by adjusting a distance between the central axis of the roller 100 and the base unit 130.

The base unit 130 applies the driving voltage to the e-paper 110 through an electrode array.

Referring to FIGS. 1 and 2, the base unit 130 includes an electrode array 131, a voltage supply unit 133, a data transmission unit 135, and e-paper fixing units 139. A control unit 140 may be included in the base unit 130 and may be provided outside the base unit 130 in some illustrative embodiments.

The electrode array 131 applies the driving voltage to the e-paper 110 and includes a plurality of electrodes formed in pixels. By way of example, an AM (active matrix) type backplane or a PM (passive matrix) type backplane can be used as the electrode array 131. Further, the electrode array 131 may be configured to form an electrode pattern in a PCB or a FPCB. In such a configuration, a voltage can be supplied to each pixel from an external circuit. A data writing voltage or a data erasing voltage can be applied to the e-paper 110 through the electrode array 131.

The voltage supply unit 133 generates voltages of various levels to be supplied through the electrode array 131 and transfer the generated voltages to the electrode array 131. By way of example, the electrode supply unit 133 supplies a scan voltage to be applied to activate horizontal electrodes and data voltage to be applied to input data to vertical electrodes. Otherwise, the voltage supply unit 133 may apply the data voltage and the erasing voltage to the entire electrode pattern without distinction between scan electrodes and data electrodes. The voltage supply unit 133 can supply voltages of various types or various levels to the electrode array 131. Further, the voltage supply unit 133 may supply a reference voltage such as a ground voltage (GND) to the e-paper 110.

The data transmission unit 135 transmits, to the control unit 140 or the electrode array 131, input data from the outside thereof. The data transmission unit 135 is configured to transfer the data voltage corresponding to the input data to the electrode array 131.

The control unit 140 controls operations of the voltage supply unit 133 and the data transmission unit 135. By way of example, when data are written, the driving voltage corresponding to the input data transmitted by the data transmission unit 135 is applied to the electrode array 131.

The control unit 140 allows the roller driving unit 102 to adjust a rotation speed of the roller 100, so that after the input data reach the electrode array 131, the roller 100 presses the e-paper 110. Details thereof will be provided with reference to FIG. 3.

FIG. 3 is a side view illustrating an operation status of a data writing apparatus in accordance with an illustrative embodiment.

As depicted in FIG. 3, as the roller 100 is moved in a predetermined direction, the roller 100 presses the e-paper 110 to be in contact with the base unit 130. In some illustrative embodiments, while the roller 100 is in a fixed state, the base unit 130 may be moved in the opposite direction to the movement direction of the roller 100 or the roller 100 and the base unit 130 may be moved in opposite directions so as to press the e-paper 110 to be in contact with the base unit 130.

Meanwhile, as the roller 100 is moved in a predetermined direction, a contact area, for example, a linear area, between the e-paper 110 and the base unit 130 is moved in the predetermined direction. In this case, the control unit 140 may transfer the input data to the electrode array 131 by a unit of a unit electrode line 112 parallel to the roller 100. Further, after the input data are applied to the unit electrode line 112, the control unit 140 controls a rotation speed of the roller 100 to pass through the unit electrode line 112.

The control unit 140 may allow the roller gap adjusting unit 104 to adjust a contact degree between the e-paper 110 and the base unit 130. By way of example, the central axis 101 is moved in a vertical direction perpendicular to the movement direction of the roller 100, so that the contact degree between the e-paper 110 and the base unit 130 can be adjusted.

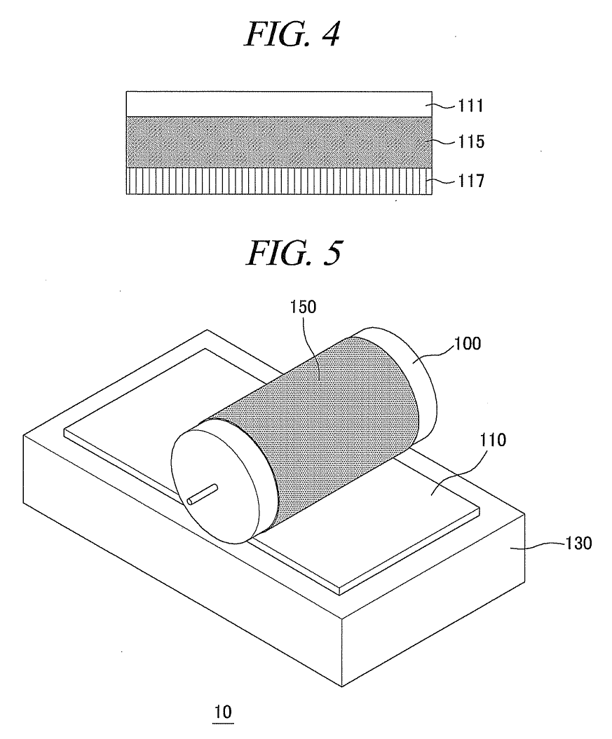

The e-paper fixing units 139 press a part of the e-paper 110 against the base unit 130 so as to prevent a change in a position of the e-paper 110 as the roller 100 is moved. Further, any one of the e-paper fixing units 139 supplies the reference voltage supplied by the voltage supply unit 133 to the e-paper 110. By way of example, in case of the e-paper 110 including a common electrode layer, a part of the common electrode layer may be exposed to the outside and the exposed part may be connected to a reference voltage supply terminal 137 so as to supply the reference voltage such as a ground voltage (GND) to the e-paper 110. That is, the e-paper fixing unit 139 serves as a connection unit configured to electrically connect the reference voltage supply terminal 137 to the common electrode layer of the e-paper 110. A detailed configuration of the e-paper will be explained with reference to FIG. 4.

FIG. 4 illustrates a configuration of e-paper used in illustrative embodiments.

E-paper depicted in FIG. 4 includes an insulation layer 111, a common electrode layer 113, a storage medium layer 115, and a substrate 117 stacked in sequence. The storage medium layer 115 may contain any one of electronic ink, a cholesteric liquid medium, an electrowetting medium, a liquid powder medium, and an electrochromic medium.

As for the e-paper depicted in FIG. 4, a part of the insulation layer 111 is removed and a part of the common electrode layer 113 is exposed to the outside in order to connect the common electrode layer 113 with an external terminal. The common electrode layer 113 exposed as described above may be supplied with a reference voltage such as a GND voltage. In this case, the base unit 130 includes a reference voltage supply terminal (not illustrated), and when the e-paper 110 is fixed to the base unit 130 by the e-paper fixing unit 139, the exposed common electrode layer 113 of the e-paper 110 is electrically connected with the reference voltage supply terminal.

FIG. 5 illustrates a data writing apparatus for e-paper in accordance with another illustrative embodiment.

The data writing apparatus depicted in FIG. 5 includes a common electrode unit 150 in addition to the roller 100 in the illustrative embodiment of FIG. 1. Unlike the illustrated embodiment of FIG. 4, the e-paper 110 of the present illustrative embodiment does not include a common electrode layer.

Since the e-paper 110 without a common electrode layer needs to be applied with a voltage from an upper side and a lower side thereof, the common electrode unit 150 is needed. The common electrode unit 150 is bonded along an outer peripheral surface of the roller 100 and applied with a voltage supplied from the voltage supply unit 133. With this configuration, when the e-paper 110 is in contact with the roller 100, a common voltage is applied to the upper side of the e-paper 110.

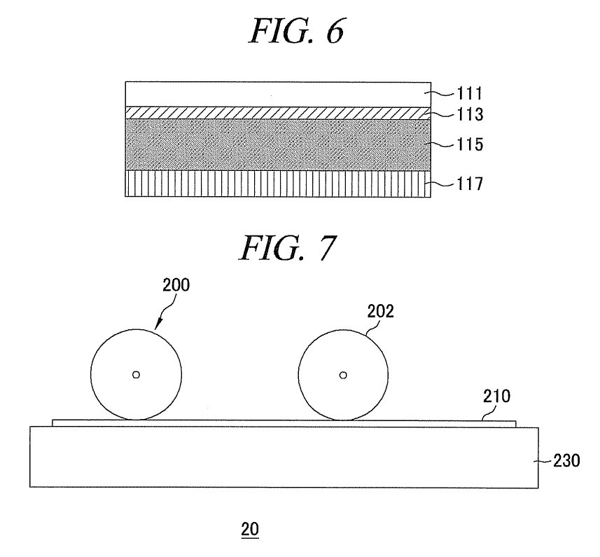

FIG. 6 illustrates a configuration of e-paper used in a data writing apparatus in accordance with another illustrative embodiment.

E-paper depicted in FIG. 6 includes the insulation layer 111, the storage medium layer 115, and the substrate 117 stacked in sequence. The storage medium layer 115 may contain any one of electronic ink, a cholesteric liquid medium, an electrowetting medium, a liquid powder medium, and an electrochromic medium.

The data writing apparatus depicted in FIG. 5 can be used for the e-paper without a common electrode layer.

FIG. 7 illustrates a data writing apparatus in accordance with still another illustrative embodiment.

A data writing apparatus 20 includes a plurality of rollers 200 and 202 on a base unit 230.

The data writing apparatus 20 includes two or more rollers 200 and 202 spaced from each other at a predetermined distance and moved in the same direction. The rollers 200 and 202 are configured to write or erase data in parallel with each other. With this configuration, a time required to write or erase data can be reduced. By way of example, if there are n rollers, a time required to write or erase data can be reduced to about a quarter (¼) of a time required for a case in which there is a single roller. As described above, the plurality of rollers is provided in a movement direction of the rollers and each roller is configured to write or erase data in a divided section on e-paper.

The control unit 140 determines in advance sections to be assigned to the rollers 200 and 202, respectively and controls the rollers 200 and 202 to write input data in the sections assigned to the rollers 200 and 202.

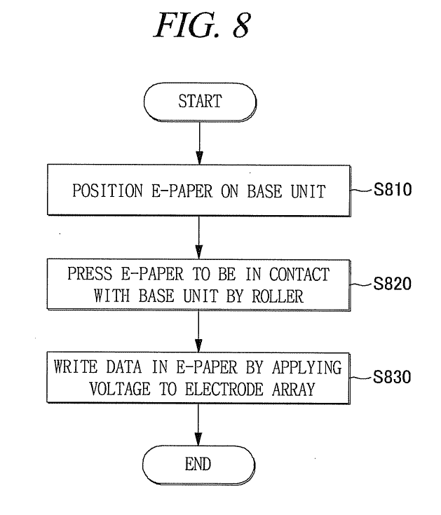

FIG. 8 is a flowchart illustrating a data writing method for e-paper in accordance with an illustrative embodiment.

The e-paper 110 is positioned on the base unit 130 (S810).

The e-paper provided in the data writing apparatus is positioned on the base unit 130 and the e-paper fixing unit 139 fixes the e-paper 110 to the base unit 130. In case of the e-paper 110 including a common electrode layer, the reference voltage supply terminal is connected to the common electrode layer of the e-paper 110 in order to supply a reference voltage to the common electrode layer.

Prior to S810, a process of removing foreign substances from a surface of the e-paper 110, particularly, a surface in contact with the base unit 130 may be performed. That is, a foreign substance removing unit (not illustrated) for removing foreign substances may be provided at an input port of the data writing apparatus, so that the foreign substances can be automatically removed in an input process. By way of example, the foreign substances may be removed by using a brush or compressed air.

Then, while the roller 100 is moved in a predetermined direction, a part of the e-paper 110 is pressed to be in contact with the base unit 130 (S820).

Thereafter, a driving voltage is applied to an electrode array of the base unit 130 during S820 so as to write input data in the e-paper 110 (S830). That is, when the e-paper 110 is pressed to be in contact with the base unit 130 by the roller 100, the driving voltage is applied to the e-paper 110. In order to do so, when the e-paper 110 is pressed to be in contact with the base unit 130, the driving voltage may be applied to an electrode array positioned at a contact point.

Otherwise, before the e-paper 110 is pressed to be in contact with the base unit 130 by the roller 100, the driving voltage may be applied in advance to an electrode array positioned at a predicted contact point. That is, the driving voltage may be continuously applied until the e-paper 110 is separated from the base unit 130 after the driving voltage is applied.

Likewise, respective scan lines of the input data may be supplied to respective electrode arrays of the base unit 130 when or before the e-paper 110 is in contact with the base unit 130.

In other words, if the roller 100 is moved in the predetermined direction, respective scan lines of the input data or a writing voltage may be applied to the respective electrode arrays of the base unit 130, so that when the e-paper 110 is in contact with the base unit 130, data can be written.

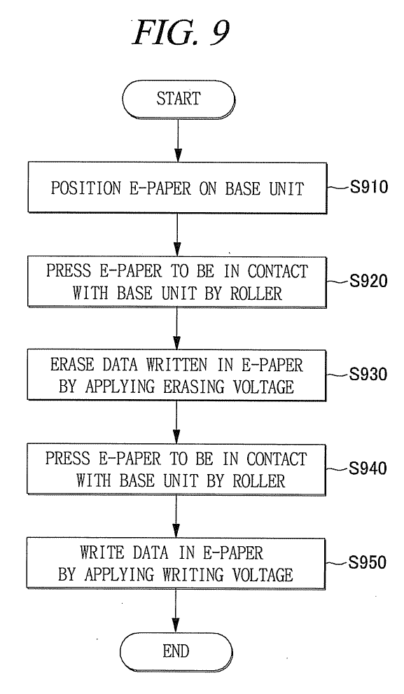

FIG. 9 is a flowchart illustrating a data writing method for e-paper in accordance with another illustrative embodiment.

In the present illustrative embodiment, prior to a process of writing data, a process of erasing data from e-paper is performed.

That is, while the e-paper 110 is pressed to be in contact with the base unit 130 by the roller 100, respective scan lines of an erasing voltage is applied to the e-paper 110 so as to erase all data written in the e-paper 110 (S930).

As described above, by erasing all the data written in the e-paper 110, it is possible to reduce or eliminate afterimages that may be generated by a memory effect of the e-paper.

After the data are erased, while the e-paper 110 is pressed to be in contact with the base unit 130 by the roller 100, respective scan lines of a data writing voltage is applied to the e-paper 110 so as to write input data in the e-paper 110 (S950).

In this case, after the data are erased while the roller 100 is moved in a first direction, the roller 100 is returned to its original position. Then, while the roller 100 is moved again in the first direction, data may be written.

Otherwise, after the data are erased while the roller 100 is moved in the first direction, data may be written while the roller 100 is moved in a second direction opposite the first direction. In the latter method as compared with the former method, a process becomes simplified and a time required for erasing and writing data can be reduced.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. A data writing apparatus for e-paper comprising:
a base unit on which the e-paper is provided and which applies a driving voltage corresponding to input data to the e-paper through an electrode array; and
a first roller that is rotatable around a central axis in a predetermined direction on the base unit and presses a part of the e-paper to be in contact with the base unit,
wherein when the e-paper is pressed to be in contact with the base unit by the first roller, the base unit applies the driving voltage to the e-paper and data are written in the e-paper.

2. The data writing apparatus of claim 1,
wherein the base unit comprises:
a voltage supply unit that supplies the driving voltage to the electrode array; and
a control unit that applies the driving voltage corresponding to the input data when a unit electrode line of the electrode array is in contact with the e-paper.

3. The data writing apparatus of claim 1, further comprising:
a roller gap adjusting unit that adjusts a gap between the first roller and the base unit to make the e-paper in close contact with a unit electrode line when the unit electrode line of the electrode array is in contact with the e-paper.

4. The data writing apparatus of claim 1,
wherein when the e-paper is pressed to be in contact with the base unit by the first roller, the base unit applies, to the e-paper, an erasing voltage for erasing the data written in the e-paper.

5. The data writing apparatus of claim 1, further comprising:
a second roller that is spaced from the first roller at a predetermined distance and rotated in the predetermined rotation direction and presses a part of the e-paper to be in contact with the base unit.

6. The data writing apparatus of claim 1,
wherein the first roller is configured to move in a first direction and the base unit is configured to move in a direction opposite the first direction.

7. The data writing apparatus of claim 1,
wherein the e-paper includes an insulating layer, a common electrode layer, a storage medium layer, and a substrate stacked in sequence.

8. The data writing apparatus of claim 1,
wherein the base unit includes:
a reference voltage supply terminal that supplies a reference voltage; and
a connection unit that connects the common electrode layer exposed to a part of the e-paper with the reference voltage supply terminal.

9. The data writing apparatus of claim 1, further comprising:
a common electrode unit that is bonded along an outer peripheral surface of the first roller and applies a common voltage to the e-paper.

10. The data writing apparatus of claim 5, further comprising:
a common electrode unit that is bonded along outer peripheral surfaces of the first roller and the second roller and applies a common voltage to the e-paper.

11. The data writing apparatus of claim 9,
wherein the e-paper includes an insulating layer, a storage medium layer, and a substrate stacked in sequence.

12. The data writing apparatus of claim 7,
wherein the storage medium layer contains any one of electronic ink, a cholesteric liquid medium, an electrowetting medium, a liquid powder medium, and an electrochromic medium.

13. A data writing method for e-paper using a data writing apparatus including a base unit that applies a driving voltage to the e-paper and a roller that is positioned on the base unit, the data writing method comprising:
(a) positioning the e-paper on an upper surface of the base unit comprising an electrode array and applying the driving voltage;
(b) pressing a part of the e-paper to be in contact with the base unit while the roller is moved in a predetermined direction; and
(c) writing data in the e-paper by applying the driving voltage to the e-paper when the e-paper is in contact with the base unit during (b) the pressing a part of the e-paper to be in contact with the base unit.

14. The data writing method of claim 13, further comprising:
prior to (a) the positioning the e-paper on an upper surface of the base unit,
removing foreign substances form a surface of the e-paper provided into the data writing apparatus.

15. A data writing method for e-paper using a data writing apparatus including a base unit that applies a driving voltage to the e-paper and a roller that is positioned on the base unit, the data writing method comprising:
(a) positioning the e-paper on an upper surface of the base unit comprising an electrode array and applying the driving voltage;
(b) pressing a part of the e-paper to be in contact with the base unit while the roller is moved in a predetermined direction;
(c) erasing data written in the e-paper by applying an erasing voltage to the e-paper when the e-paper is in contact with the base unit during (b) the pressing a part of the e-paper to be in contact with the base unit;
(d) pressing a part of the e-paper to be in contact with the base unit while the roller is moved in a predetermined direction; and
(e) writing data in the e-paper by applying a writing voltage to the e-paper when the e-paper is in contact with the base unit during (d) the pressing a part of the e-paper to be in contact with the base unit.

16. The data writing method of claim 15,
wherein during (d) the pressing a part of the e-paper to be in contact with the base unit, the roller is moved in a direction opposite the direction of (b) the pressing a part of the e-paper to be in contact with the base unit.

17. The data writing method of claim 15, further comprising:
after (c) the erasing data written in the e-paper and before (d) the pressing a part of the e-paper to be in contact with the base unit,
moving the roller to its original position,
wherein during (d) the pressing a part of the e-paper to be in contact with the base unit, the roller is moved in the same direction as the direction of (b) the pressing a part of the e-paper to be in contact with the base unit.

18. The data writing method of claim 13,
wherein the data writing apparatus includes a plurality of rollers that is spaced from each other at a predetermined distance and rotated in a predetermined rotation direction and presses a part of the e-paper to be in contact with the base unit.
